(19) United States
(12) Patent Application Publication
(10) Pub. No.: US 2004/0045329 A1
(43) Pub. Date: Mar. 11, 2004

(54) Lockable storage unit with tether

(76) Inventors: Mark P. Farnham, Port Jefferson, NY (US); Clive Warwicker, Worcestershire (GB)

Correspondence Address: PILLSBURY WINTHROP, LLP, P.O. BOX 10500, MCLEAN, VA, 22102, US

(21) Appl. No.: 10/237,215

(22) Filed: Sep. 9, 2002

(51) Int. Cl. E05B 65/52

(52) U.S. Cl. 70/63; 70/161

(57) ABSTRACT

A storage unit for storing items has a base with an upstanding sidewall and a lid having a depending sidewall movably coupled to the base. An upwardly open groove is formed in the upstanding sidewall or the depending sidewall and is configured to receive one end of a tether, which can be disposed within an interior of the base or the lid to abut the upstanding sidewall or the depending sidewall. The lid or the base being configured to close at least a portion of the groove to prevent withdrawal of the one end of the tether from the interior of the base or the lid when the lid and the base are moved into the closed position thereof. A method of storing items is also provided.

### BACKGROUND OF THE INVENTION

1. Field of the Invention

The invention relates generally to storage units and, more specifically, to storage units that facilitate lockingly storing items therein.

2. Related Information

Generally, storage units for storing items such as documents, jewelry, cash or other valuable items include a base capable of enclosing an interior space provided therein to store items and a lid pivotally connected to the base to enclose the interior space thereof when moved into a closed position. The base may include locking structure to lockingly secure stored items therein when the base and the lid are moved into the closed position thereof. Although storage units of this type may be locked to lockingly secure stored items therein, the storage units do not prevent theft of the storage unit itself, thereby allowing theft of the stored items. Upon such theft, a thief could gain access to the stored items stored in the interior space of the base, which is potentially dangerous and highly undesirable.

For this reason, storage units have been provided with securing members, in the form of cables or chains, for securing the storage units to stationary or immovable objects. Examples of such storage units can be found in U.S. Pat. Nos. 4,474,116, 4,573,332 and 5,531,082.

### SUMMARY OF THE INVENTION

One aspect of the present invention is to provide a storage unit that facilitates lockingly storing items therein.

Another aspect of the present invention is to provide a storage unit that facilitates lockingly storing items therein and that can be secured to an immovable object.

A further aspect of the present invention is to provide a tether of a relatively short length, which saves material, to secure the storage unit to an immovable object.

Yet another aspect of the present invention is to provide a method of storing items for storage.

Still another aspect of the present invention is to provide a storage unit that is easy to assemble.

A further aspect of the present invention is to provide a method of retrofitting an existing storage unit for securement to an immovable object.

According to one embodiment of the present invention, a storage unit comprises a base with an upstanding peripheral sidewall and an upwardly open groove formed in the upstanding peripheral sidewall. A lid has a depending peripheral sidewall and is pivotally coupled to the base via a hinge for relative pivotal movement therebetween. The lid and the base are movable into a closed position wherein the lid substantially encloses the base. The depending sidewall has a lower peripheral portion that abuts an upper peripheral portion of the upstanding sidewall when the lid and the base are moved into their closed position. A tether has a looped segment on a trailing end thereof for securing to an immoveable object and a retaining element on a leading end thereof. A locking device may be provided which is capable of lockingly securing the lid and the base to one another to prevent relative pivotal movement therebetween. The groove within the upstanding sidewall extends past the lower peripheral portion of the depending sidewall when the lid and the base are moved into their closed position. The leading end of the tether is capable of being disposed within the groove such that the retaining element is disposed within an interior of the base. The groove may be enclosed with the depending sidewall of the lid and the retaining element may abut the sidewall to prevent withdrawal of the leading end of the tether from the interior of the base.

A method of storing items for storage comprises providing a storage unit that comprises a base with an upstanding peripheral sidewall. Providing a lid having a depending peripheral sidewall and being movably coupled to the base via a hinge for relative pivotal movement therebetween. The lid and the base can be moved into a closed position wherein the lid substantially encloses the base. The depending sidewall has a lower peripheral portion that abuts an upper peripheral portion of the upstanding sidewall when the lid and the base are moved into their closed position. The method further includes forming a groove in the upstanding peripheral sidewall of the base and providing a tether having a looped segment on a trailing end thereof for securing to the immoveable object and a retaining element on a leading end thereof. The groove can be extended past the lower peripheral portion of the depending sidewall or past the upper peripheral portion of the upstanding sidewall when the lid and the base are moved into their closed position. The leading end of the tether is enabled to be disposed within the groove such that the retaining element is disposed within an interior of the base or the lid. The groove is at least partially enclosed with the depending sidewall of the lid or with the upstanding sidewall of the base. The leading end of the tether is abutted with depending sidewall of the lid or the upstanding sidewall of the base to prevent withdrawal of the leading end of the tether from the interior of the base or the lid.

Other aspects and features of the invention will become apparent from the following detailed description of preferred embodiments.

### BRIEF DESCRIPTION OF THE DRAWINGS

The above and other features of the present invention are further described in the detailed description which follows, with reference to the drawings, wherein like reference numerals represent similar elements of the invention throughout the several views and wherein:

FIG. 1 is a perspective view of a storage unit according to one embodiment of the invention, the storage unit having a base and a lid pivotally connected to one another and moved in a closed position thereof, the storage unit being secured to an immovable object with a tether extending from the base;

FIG. 2 is a front perspective view of the storage unit of FIG. 1, with the tether extending therefrom for securement to the immovable object;

FIG. 3 is a front perspective view similar to FIG. 2, with the lid and the base in an open position thereof to provide access to an interior of the base;

FIG. 4 is an enlarged view of the section marked 4-4 in FIG. 3 to better show the groove formed in the base;

FIG. 5 is an enlarged view similar to FIG. 4, but showing the tether received in the groove to extend from the base;

FIG. 6 is a perspective view of a storage unit according to another embodiment of the invention, the storage unit having a base and a lid pivotally connected to one another and moved in a closed position thereof, the storage unit being secured to an immovable object with a tether extending from the base;

FIG. 7 is a front perspective view of the storage unit of FIG. 6, with the tether extending therefrom for securement to the immovable object;

FIG. 8 is a front perspective view similar to FIG. 7, but showing the lid and the base in a fully open position thereof;

FIG. 9 is a perspective view of a storage unit according to yet another embodiment of the invention, the storage unit having a base and a lid pivotally connected to one another and moved in a closed position thereof, the storage unit being secured to an immovable object with a tether extending from the base;

FIG. 10 is a rear perspective view of the storage unit of FIG. 9, with the tether extending therefrom for securement to the immovable object;

FIG. 11 is a rear perspective view similar to FIG. 10, but showing the lid and the base in an open position thereof to better show a storage tray positioned in the base;

FIG. 12 is a rear perspective view similar to FIG. 11, but showing the lid and the base in a fully open position thereof with the storage tray removed from the base to better show a locking structure for lockingly securing the lid and the base in a closed position thereof;

FIG. 13 is a front perspective view similar FIG. 11, but showing the lid and the base in the open position thereof with the storage tray positioned in the base;

FIG. 14 is a front perspective view of the storage tray shown in FIG. 13;

FIG. 15 is a front view of the storage tray shown in FIG. 14; and

FIG. 16 is a rear view of the storage tray shown in FIG. 14.

### DETAILED DESCRIPTION OF PREFERRED EMBODIMENTS

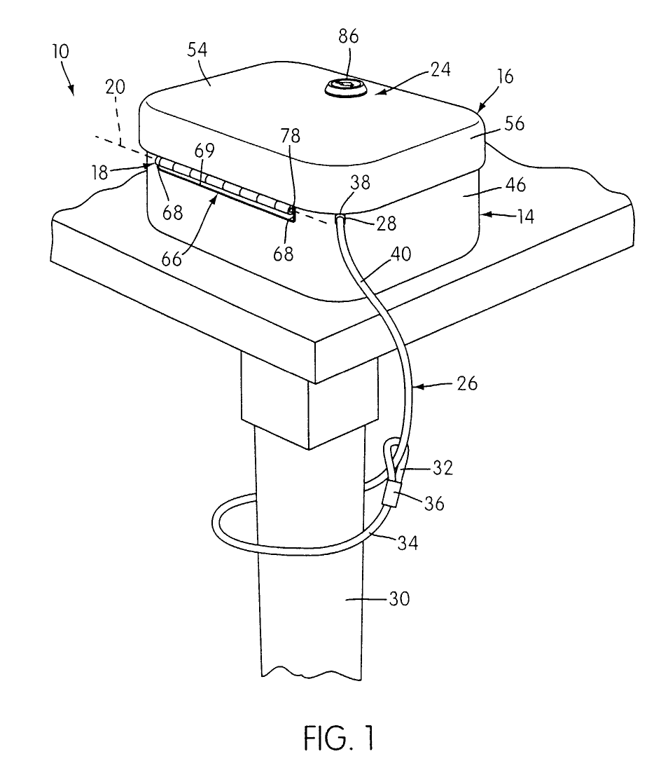

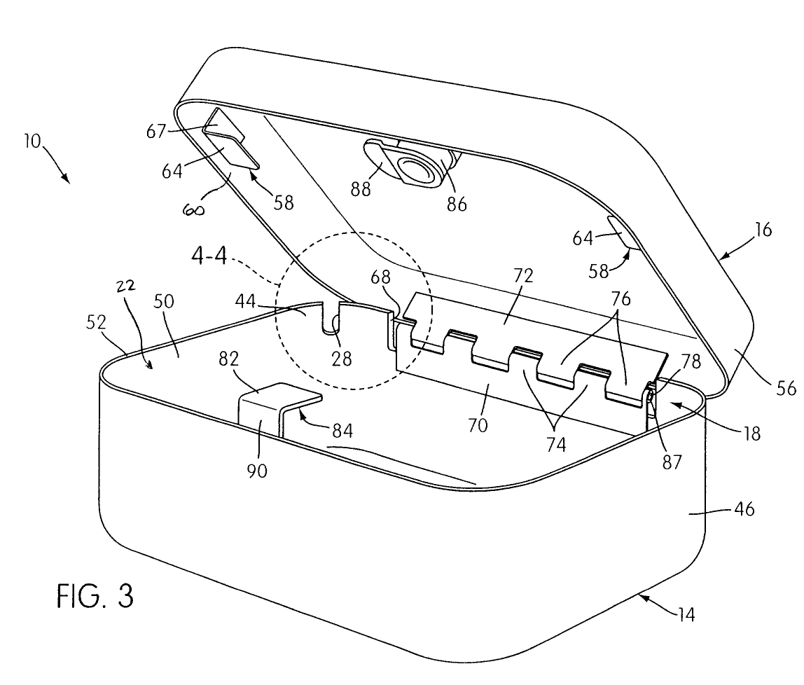

Referring now more particularly to the drawings, FIGS. 1-5 illustrate a storage unit according to the invention, generally indicated at 10, for storing an item or items 12 (FIG. 3) to be stored. Such items may include documents, cash, jewelry or other valuable or non-valuable items. The storage unit 10 includes a base 14 and a lid 16 pivotally coupled to one another by a hinge 18 for relative pivotal movement therebetween about a pivot axis 20, as described in greater detail below.

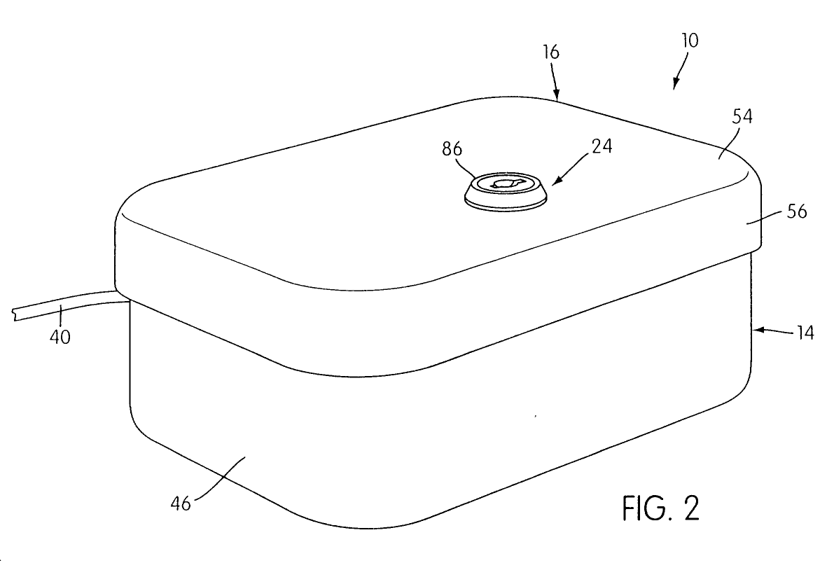

The base 14 and the lid 16 are movable into a closed position (FIGS. 1 and 2), wherein the lid 16 substantially encloses an interior 22 of the base 14 and an open position (FIG. 3), wherein the lid 16 is positioned to provide access to the interior 22 of the base 14. The storage unit 10 may include a locking device 24, such as a key lock or any other key actuated lock, for example, configured to be capable of lockingly securing the base 14 and the lid 16 to one another in the closed position thereof to prevent relative pivotal movement therebetween. The locking device 24 can be provided at any position on the base 14 or the lid 16 and is only shown in a forward portion of the storage unit 10 as one example of its position.

A tether, generally indicated at 26, is slidably received in an upwardly open groove 28 formed in the base 14 for securing the storage unit 10 to an immoveable object 30, such as a table or other structure fixedly connected to a surface (not shown), for example. The tether 26 may be, for example, a cable tether, a chain tether, or another tether suitable for securing the storage unit 10 to an immovable object. The tether 26 is of relative short length to save material and has a looped segment 32 formed on a trailing end 34 thereof by a clamping 36, which may be a metal structure, for example, clamped around a portion of the trailing end 34.

Although the groove 28 is illustrated in a rearward portion of the upstanding wall 46 of the base 14 in FIG. 1, the groove 28 may be positioned anywhere in the upstanding wall 46 or in the depending sidewall 56 of the lid 16.

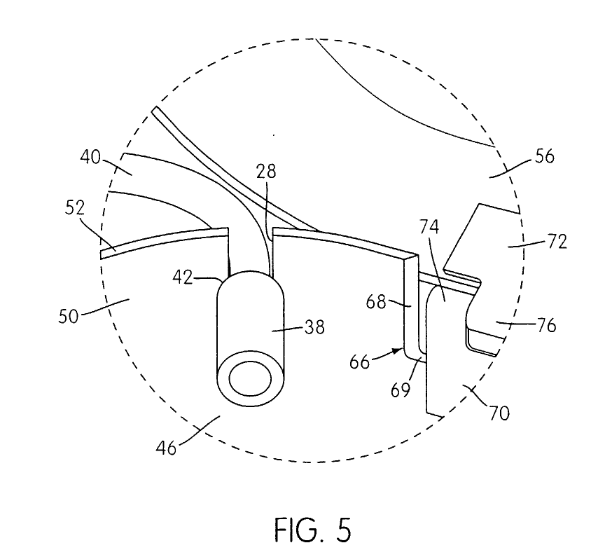

A retaining element 38 (best seen in FIG. 5), in the form of an enlarged portion, is provided on a leading end 40 of the tether 26, for example, by fixedly attaching the retaining element 38 thereto. The retaining element 38 is slightly oversized with respect to the groove 28 and includes a sidewall abutting surface 42 on one end thereof (the end closest to the trailing end 34 of the tether 26), which is configured to engage an interior marginal surface 44 surrounding the upwardly facing groove 28. That way, when the tether 26 is a cable or other similar tether, the retaining element 38 allows the leading end 40 of the tether 26 to be slidably received in the groove 28 without being pulled out from the groove 28. For example, the sliding relationship between the tether 26 and the groove 28 can allow the leading edge 40 of the tether 26 to be moved inside of (and stored within) the base 14, which might occur if the storage unit 10 is moved toward the immovable object 30 while the tether 26 is attached thereto.

FIG. 1 shows the looped segment 32 positioned around the immovable object 30 and after the leading end 40 of the cable was threaded through the looped segment 32 to secure the tether 26 to the immoveable object 30. With the base 14 and the lid 16 moved into their closed position, the retaining element 38 is secured within the groove 28 to secure the storage unit 10 to the immovable object 30.

The relationship between the tether 26 and the groove 28 allows the storage unit 10 to be secured to immovable object 30 with a relatively simple construction. This simple construction eases assembly of the storage unit 10 and allows the tether 26 and the groove 28 to be retrofitted on bases, lids or both bases and lids of existing storage units.

Alternatively, when the tether is a chain tether, for example, one or more links of the chain tether may form the retaining element 38. Also, when the tether is chain tether, the chain tether can be looped around the immovable object 30 so that both the leading end and the trailing end are positioned in the groove 28, for example. A locking device (not shown), such as a pad lock, for example, could be provided to lockingly secure the trailing end around the immovable object 30 while the leading end is secured within the groove 28.

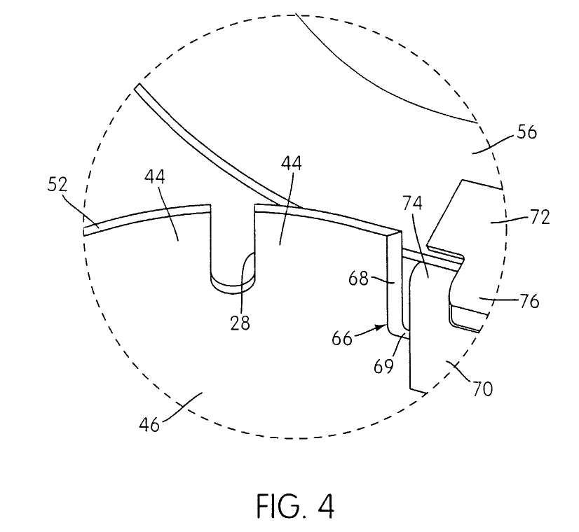

As shown in FIGS. 2 and 3, the base 14 has an upstanding peripheral sidewall 46 and a generally flat bottom surface 48 integrally formed with the upstanding peripheral sidewall 46. As best seen in FIG. 4, the upstanding peripheral sidewall 46 extends upwardly from the entire perimeter of the bottom surface 48 to form the interior 22 of the base 14. The bottom surface 48 is capable of being covered with a removable protection pad (not shown) for protecting or supporting the item or items 12 and for protecting the bottom surface 48. The upstanding peripheral sidewall 46 has an upper peripheral portion 50 defining an upper surface 52 thereof.

The lid 16 has a generally flat upper surface 54 and a depending peripheral sidewall 56 integrally formed with the upper surface 54. The depending peripheral sidewall 56 extends downwardly from the entire perimeter of the upper surface 54 of the lid 16. A handle (not shown) could be pivotally connected to the upper surface 54 of the lid 16 to facilitate transport of the storage unit 10 from location to location.

A pair of stop members 58 (FIG. 3) may extend from the depending sidewall 56 of the lid 16 to define a lower peripheral portion 60 of the depending sidewall 56 therebelow. In FIG. 3, the stop members 58 are shown as L-shaped structures having a first end 62 thereof connected to the depending sidewall 56 and having a second end 64 thereof configured to abut the upper surface 52 of the upstanding sidewall 46 when the base 14 and the lid 16 are moved into their closed position. The first end 62 of the stop members 58 may be integrally formed with the depending sidewall 56, or alternatively, may be fixedly connected thereto by adhesive, bonding material or fasteners, such as bolts, rivets or screws.

FIGS. 1-3 show the lower peripheral portion 60 of the depending sidewall 56 overlapping the upper peripheral portion 50 of the upstanding sidewall 46 when the base 14 and the lid 16 are moved into their closed position. As a result, the lower peripheral portion 60 overlaps an uppermost portion of the groove 28 when the base 14 and the lid 16 are moved into their closed position. This overlapping secures the retaining element 38 at the leading end 40 of the tether 26 within the interior 22 of the storage unit 10.

Alternatively, a lower surface of the depending sidewall 56 could abut an upper surface of the upstanding sidewall 46 when the base 14 and the lid 16 are moved into their closed position. Other configurations are also possible provided that a portion of either the base 14 or the lid 16 at least partially closes the opening formed by the groove 28. For example, if the groove 28 were formed in the lid 16, then a portion of the base 14 could at least partially close the opening formed by a lowermost portion of the groove 28 to thereby secure a retaining element 38 of a tether within an interior 22 of the storage unit.

The upstanding sidewall 46 and the bottom surface 48 of the base 14 and the upper surface 52 and the depending sidewall 56 of the lid 16 may be formed from sheet metal, for example, by stamping or machining. In general, the components of the base 14 and the lid 16 can be made from metal or any other suitable material such as plastic, wood, or other rugged material and may be formed by molding or other manufacturing processes.

The integral construction of the base 14 and the lid 16 generally provides a more cost-effective and stronger structure than bases and lids of other types. Any type of lid may be used so long as the lid is capable of enclosing an interior of the base. Because the groove can be positioned on either the base or the lid, any type of lid or base may be used so long as the lid or the base is capable of at least partially closing a portion of the groove when the lid and the base are moved into a closed position thereof.

In addition to defining the upwardly facing groove 28, the upstanding sidewall 46 defines a recessed portion 66 in a rear section thereof, as shown in FIGS. 1, 3, 4 and 5. The recessed portion 66 is generally U-shaped with an open end thereof facing upwardly. The recessed portion 66 has substantially vertically extending side portions 68 extending from a central portion 69 thereof and defining a horizontal plane therebetween. The recessed portion 66 is configured to substantially surround a portion of the hinge 18 so that the pivot axis 20 is positioned rearwardly of the horizontal plane extending between the side portions 68. Thus, the hinge 18 can pivot about the pivot axis 20 without obstruction.

As shown in FIGS. 3-5, the hinge 18 permits the lid 16 to pivot with respect to the base 14 between the open position (FIG. 3) thereof and the closed position (FIGS. 1 and 2) thereof. As briefly mentioned above with respect to FIG. 1, the lid 16 pivots about the pivot axis 20. In the open position thereof, the base 14 and the lid 16 may be pivoted relative to one another up to an angle of about 180° such that the upper surface 54 of the lid 16 and the bottom surface 48 of the base 14 lie along substantially the same horizontal plane. FIGS. 4 and 5 show the hinge 18 in greater detail. The hinge 18 comprises cooperating hinge structures 70, 72, one cooperating hinge structure 70 extending from the upstanding sidewall 46 of the base 14 and the other cooperating hinge structure 72 extending from the depending sidewall 58 of the lid 16. The cooperating hinge structures 70, 72 may be integrally formed with the respective sidewall 46, 56 of the base 14 and the lid, respectively, or alternatively, may be fixedly connected thereto by adhesive, bonding material or fasteners, such as bolts, rivets or screws.

The hinge structures 70, 72 include a plurality of extension members 74, 76, each providing associated journaling openings 78 therein, such that the journaling openings 78 are aligned in a series. Only journal openings 78 are shown in FIGS. 1 and 3, but since the journal openings 78, 80 have substantially identical structure, the description for the journal openings 78 will suffice for the journal openings 80. The extension members 74, 76 alternately extend from the lower peripheral portion 60 of the lid 16 and from the upper peripheral portion 50 of the base 14 such that each extension member 76 extending from the lid 16 is positioned adjacent an extension member 74 extending from the base 14 and vice versa. A shaft member 82, e.g., in the form of a pin-type axle member, may be supported in the journaling openings 78, 80 and may be retained therein by suitable securing means. The journaling openings 78, 80 are generally circular and completely surround the shaft member 82. Thus, the journaling openings 78, 80 cooperate with the shaft member 82 to form the pivot axis 22, which allows the lid 16 to pivot about the pivot axis 22 relative to the base 14 without obstruction.

Alternatively, in an embodiment not shown, each vertically extending side portion of the recessed portion 66 could provide a journaling opening therein. In this regard, the lid 16 could include circular shaft members (not shown) extending outwardly from a plurality of extension members (not shown) formed on opposite sides of the depending sidewall of the lid. The journaling openings would be circular and would completely surround the associated shaft member. The shaft members would be positioned relative to the bottom, rear edge of the lid so as to allow the lid to pivot about a pivot axis without obstruction.

In this alternative embodiment, the cylindrical shaft members (not shown) could be inserted into the journaling openings (not shown) by a spring type deflection. For example, one shaft member would be inserted into its journaling opening and the extension member carrying the other shaft member would be flexed away from the vertically extending side portion such that the associated shaft member could be inserted into its journaling opening to pivotally attach the lid to the base.

Alternatively, the hinge 18 could be a living hinge formed of a bendable material, such as plastic, for example. The living hinge (not shown) might have a lower portion thereof attached to the upper peripheral portion 50 of the upstanding sidewall 46 of the base 14 and an upper portion thereof attached to the lower peripheral portion 60 of the depending sidewall 56 of the lid 16. If a hinge of this type is implemented, the recessed portion 66 formed in the rear section of the upstanding sidewall 46 may be eliminated because the living hinge, without the recessed portion 66 being formed in the upstanding sidewall 46, would allow the lid 16 to pivot about the pivot axis 20 without obstruction.

Various types of hinges are described above, as examples only and are not meant to limit the invention to those specific hinges. For example, the lid 16 could provide journaling openings (not shown) on opposite sides thereof and the base 14 could include cylindrical shaft members (not shown) to be inserted into the journaling openings by a spring type deflection or the lid 16 could be removably attached to the base 14.

FIGS. 1 and 3 show the locking device 24 in greater detail. The locking device 24 includes a lock receiving structure 84 provided on one of the base 14 and the lid 16. The locking device 24 also includes a lock actuating portion in the form of a key receiving portion 86 and a locking flange 88 provided on the other of the base 14 and the lid 16, opposite the lock receiving structure 84.

Although FIGS. 1-3 show the locking device 24 at a forward portion of the storage unit 10 as described above, the locking device 24 can be positioned anywhere on the base 14 or the lid 16 of the storage unit 10 and may include alterative locking structure.

In this embodiment, as shown in FIG. 3, the lock receiving structure 84 has an L-shaped configuration and is positioned on a front section of the upstanding sidewall 46. A first portion 90 of the lock receiving structure 84 is connected to or integrally extends from the upstanding sidewall 46 to extend partially above the upper surface 52 of the upstanding sidewall 46. A second portion 92 of the lock receiving structure 84 extends substantially perpendicular from the first portion 90 toward the hinge 18. In FIGS. 1 and 3, the key receiving portion 86 and the locking flange 88 are provided on the lid 16 and are configured to be capable of cooperating with the second portion 92 of the lock receiving structure 84 to lockingly secure the base 14 and the lid 16 to one another to prevent relative pivotal movement therebetween. Specifically, the locking flange 88 is rotatably mounted to the key receiving portion 86 such that rotation of the key receiving portion 86, e.g., by turning a key inserted into the key receiving portion 86 to a locked or an unlocked position, rotates the locking flange 88 into its locked or unlocked position, respectively. In its unlocked position, the locking flange 88 is aligned parallel to the hinge 18. In its locked position, the locking flange 88 is rotated to be perpendicular to the hinge 18, whereby the locking flange 88 engages the underside of the second portion 92 of the lock receiving structure 84 to prevent upward or pivotal movement of the lid 16.

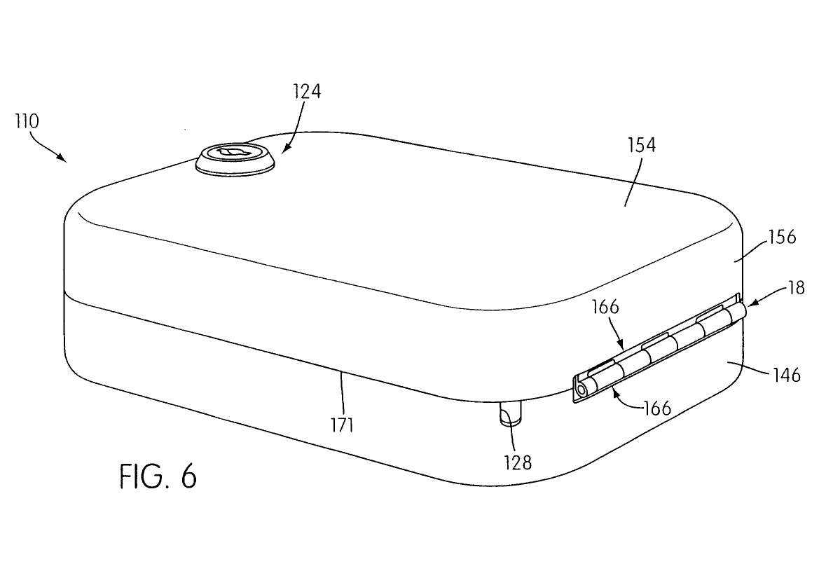

FIGS. 6-8 show a storage unit, generally indicated at 110, according to another embodiment of the invention. Because the storage unit 110 is substantially identical in configuration and operation as the storage unit 10, only the differences between the storage unit 10 and the storage unit 110 will be described below.

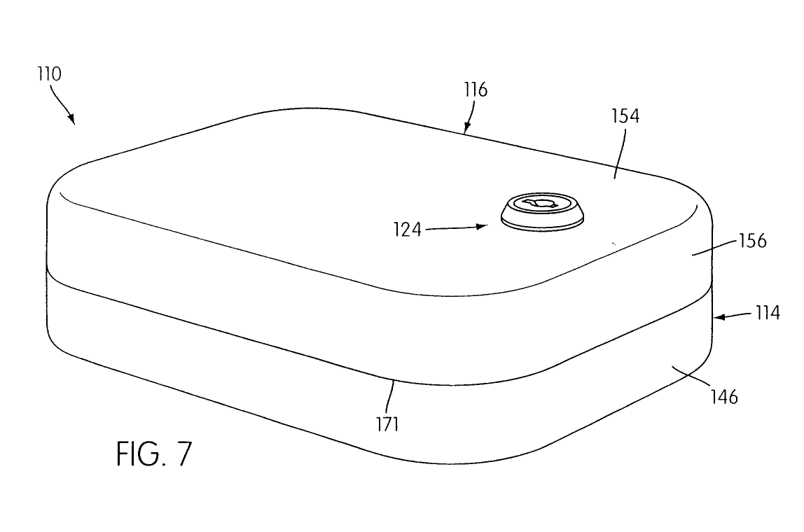

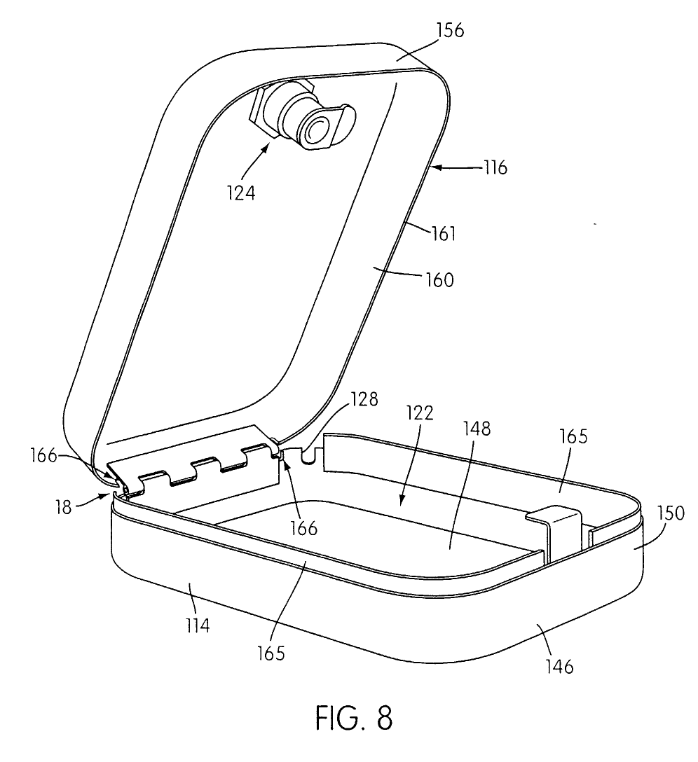

The storage unit 110 includes a base 114 and a lid 116 pivotally coupled to one another by the hinge 18. The base 114 and the lid 116 are movable into a closed position (FIGS. 6 and 7), wherein the lid 116 substantially encloses an interior 122 of the base 114 and an open position (FIG. 8), wherein the lid 116 is positioned to provide access to the interior 122 of the base 114. The storage unit 110 may include the locking device 24 configured to be capable of lockingly securing the base 114 and the lid 116 to one another in the closed position thereof to prevent relative pivotal movement therebetween.

The base 114 has an upstanding peripheral sidewall 146 and a generally flat bottom surface 148 integrally formed with the upstanding peripheral sidewall 146. As best seen in FIG. 8, the upstanding peripheral sidewall 146 extends upwardly from the entire perimeter of the bottom surface 148 to form the interior 122 of the base 114. The bottom surface 148 is capable of being covered with a removable protection pad (not shown) for protecting or supporting the item or items 112 and for protecting the bottom surface 148. A groove 128 is formed in the upstanding sidewall 146 to be substantially identical to the groove 28 formed in the upstanding sidewall 46, as shown in FIGS. 4-5. The upstanding peripheral sidewall 146 has an upper peripheral portion 150 defining an upper surface 152 thereof.

The lid 116 has a generally flat upper surface 154 and a depending peripheral sidewall 156 integrally formed with the upper surface 154. The depending peripheral sidewall 156 extends downwardly from the entire perimeter of the upper surface 154 of the lid 16.

Each of the upstanding sidewall 146 and the depending sidewall 156 may have a recessed portion 166, substantially identical in configuration and operation as the recessed portion 66 shown in FIG. 1, formed therein. The recessed portions 166 could provide enough space for the hinge 18 to operate without obstruction.

Although not shown in this embodiment, a handle could be pivotally connected to the upper surface 54 of the lid 16 to facilitate transport of the storage unit 10 from location to location.

The depending peripheral sidewall 156 has a lower peripheral portion 160 defining a lower surface 161 thereof. The lower surface 161 is configured to abut the upper surface 152 of the upper peripheral portion 150 when the base 114 and the lid 116 are moved into the closed position thereof.

A pair of arcuate guide members 165 extend upwardly from the upper peripheral portion 150 of the base 114 on opposite sides thereof. The arcuate guide members 165 may be integrally formed with the depending sidewall 146, or alternatively, may be fixedly connected thereto by adhesive, bonding material or fasteners, such as bolts, rivets or screws. Exterior portions of the arcuate guide members 165 engage and cooperatively guide interior areas of the lower peripheral portion 160 of the lid member 116 as the base 114 and the lid 116 are moved into the closed position thereof.

Although the groove 128 is illustrated rearwardly of the arcuate guide members 165 in FIG. 8, the groove 128, like the groove 28 in FIG. 1, may be positioned anywhere in the upstanding wall 146, the depending sidewall 56 or in the arcuate guide members 165.

No stop members are needed in the storage unit 110 when the base 114 and the lid 116 are moved into the closed position thereof because a lower surface 161 of the lower peripheral portion 160 of the lid 116 abuts against the upper surface 152 of the upper peripheral portion 150 of the base 114 to stop relative pivotal movement between the base 114 and the lid 116. When the base 114 and the lid 116 are moved into the closed position thereof, the lower surface 161 at least partially closes the groove 128 to secure the cable 22 therein, as described above with respect to groove 28 in FIG. 1.

In the closed position, the upper peripheral portion 150 of the base 114 and the lower peripheral portion 160 of the lid 116 coextend flush with one another so as to form a substantially smooth seam 171 between the base 114 and the lid 116. In contrast to the storage unit 10 described above, the lower peripheral portion 160 of the lid 116 does not overlap the upper peripheral portion 150 of the base 114.

Similar to the storage unit 10, the upstanding sidewall 146 and the bottom surface 148 of the base 114 and the upper surface 154 and the depending sidewall 156 of the lid 116 may be formed from sheet metal, for example, by stamping or machining. In general, the components of the base 114 and the lid 116 can be made from metal or any other suitable material such as plastic, wood, or other rugged material and may be formed by molding or other manufacturing processes.

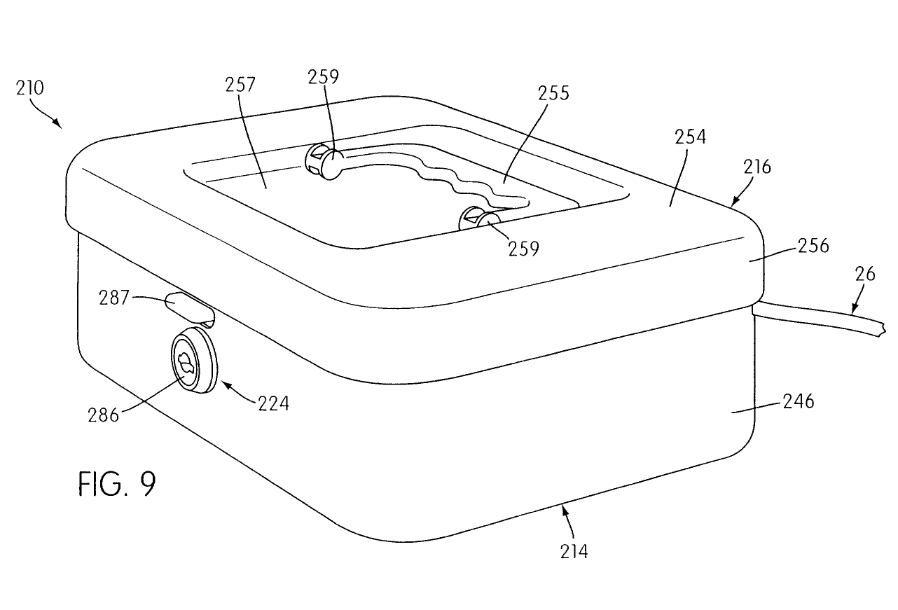

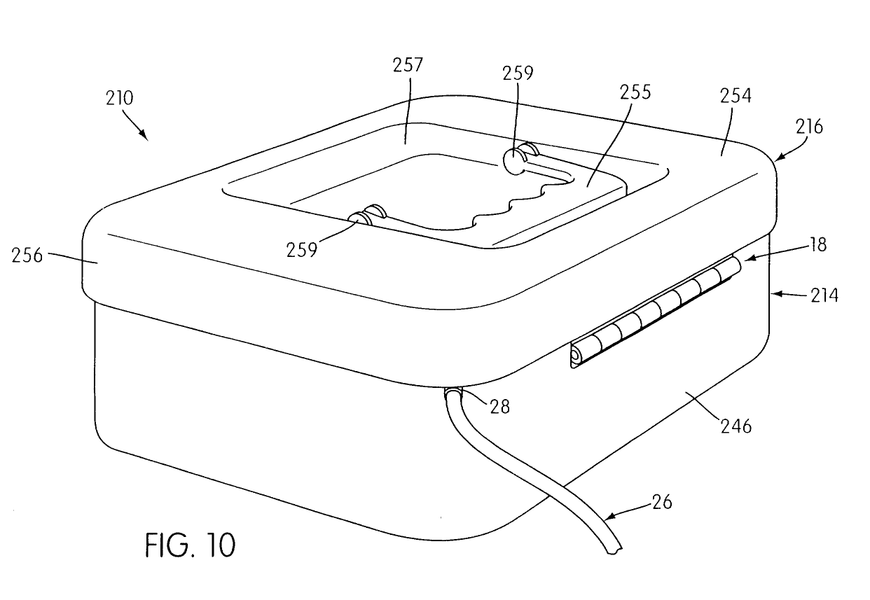

FIGS. 9-13 show a storage unit, generally indicated at 210, according to another embodiment of the invention. Because the storage unit 210 is substantially identical in configuration and operation as the storage unit 10, only the differences between the storage unit 10 and the storage unit 210 will be described below.

The storage unit 210 includes a base 214 and a lid 216 pivotally coupled to one another by the hinge 18. The base 214 and the lid 216 are substantially the same in both structure and operation as the base 14 and the lid 16, except for the lid 216 includes a handle 255 pivotally connected to an upper surface 254 thereof to facilitate transport of the storage unit 210 from location to location. When not in use, the handle 255 is disposed in a recessed portion 257 of the upper surface 254 and pivotally connected to the recessed portion 257 by suitable securing means, for example, shaft members 259 provided on the handle 255 and journaling openings (not shown) provided in the recessed portion 257 to receive the shaft members 259 on the handle 255.

The storage unit 210 may include a locking device 224, which is an alterative locking device than locking device 24. The locking device 224 is configured to be capable of lockingly securing the base 214 and the lid 216 to one another in the closed position thereof to prevent relative pivotal movement therebetween.

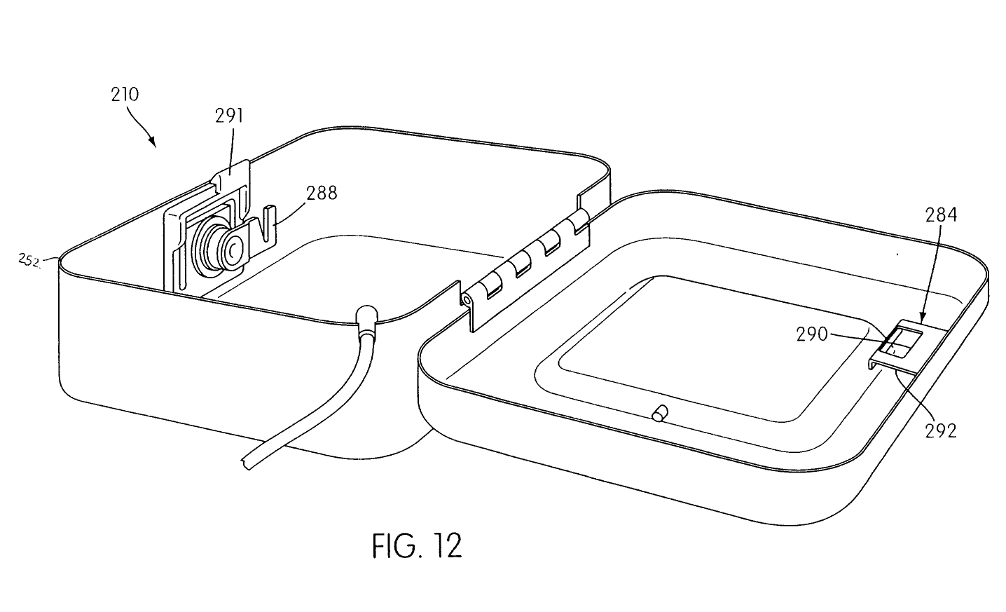

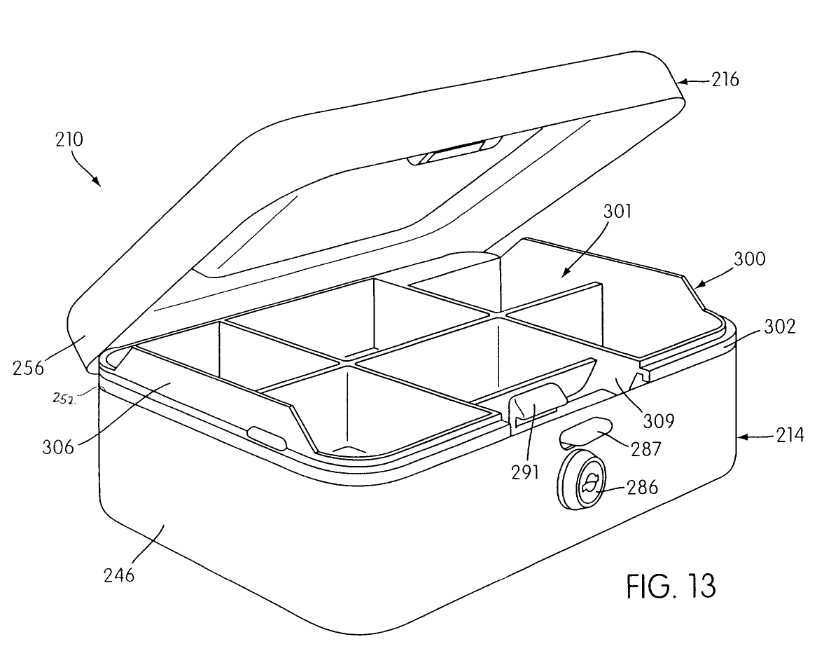

The locking device 224 includes a lock receiving structure 284 provided on one of the base 214 and the lid 216. The locking device 224 further includes a lock actuating portion in the form of a key receiving portion 286, a locking flange 288 and an actuator 287 including a tab 291 provided on the other of the base 214 and the lid 216, opposite the lock receiving structure 284. In this embodiment, as shown in FIGS. 12 and 13, the lock receiving structure 284 is positioned on a front section of the depending sidewall 256 of the lid 216 and the actuator 287 extends through the upstanding sidewall 246 of the base 214. An opening 290 is provided in the lock receiving structure 284 and adjacent to a tab engaging portion 292. The lock receiving structure 284 is connected to or integrally extends from the depending sidewall 256 to extend toward the hinge 18.

In FIGS. 12 and 13, the key receiving portion 286, the locking flange 288 and the actuator 287 including the tab 291 are provided on the base 214 and are configured to be capable of cooperating with the opening 290 and the tab engaging portion 292 of the lock receiving structure 284 to lockingly secure the base 214 and the lid 216 to one another to prevent relative pivotal movement therebetween.

Specifically, the actuator 287 and the tab 291 cooperate with the lock receiving structure 284 via a spring type deflection to secure the lid 216 and the base 214 in the closed position thereof. For example, as the lid 216 and the base 214 are moved into the closed position thereof, the lid 216 is moved so that the tab 291 abuts the lock receiving structure 284. To close the storage unit 210, actuation of the actuator 287 deflects the tab 291 toward the hinge 18, which allows the tab 291 to extend through the opening 290 and to engage the tab engaging portion 292. When the tab 291 engages the tab engaging portion 292, the storage unit 210 is securely closed, but not locked.

To lock the storage unit 210, the locking flange 288 must be activated. The locking flange 288 is rotatably mounted to the key receiving portion 286 such that rotation of the key receiving portion 286, e.g., by rotating a key inserted into the key receiving portion 286 to a locked or an unlocked position, rotates the locking flange 288 into its locked or unlocked position, respectively. In its unlocked position, the locking flange 288 is aligned parallel to the hinge 18. The storage unit 210 can be opened and closed using the actuator 287 when the locking flange 288 is in its unlocked position.

In its locked position, the locking flange 288 is rotated to be perpendicular to the hinge 18, whereby the locking flange 288 engages one of the edges of the tab engaging portion 292 of the lock receiving structure 284 to prevent upward or pivotal movement of the lid 216. The storage unit 210 cannot be opened using the actuator 287 when the locking flange 288 is in its locked position.

Similar to the storage units 10, 110, the upstanding sidewall 246 of the base 214 and the upper surface 254 and the depending sidewall 256 of the lid 216 may be formed from sheet metal, for example, by stamping or machining. In general, the components of the base 214 and the lid 216 can be made from metal or any other suitable material such as plastic, wood, or other rugged material and may be formed by molding or other manufacturing processes.

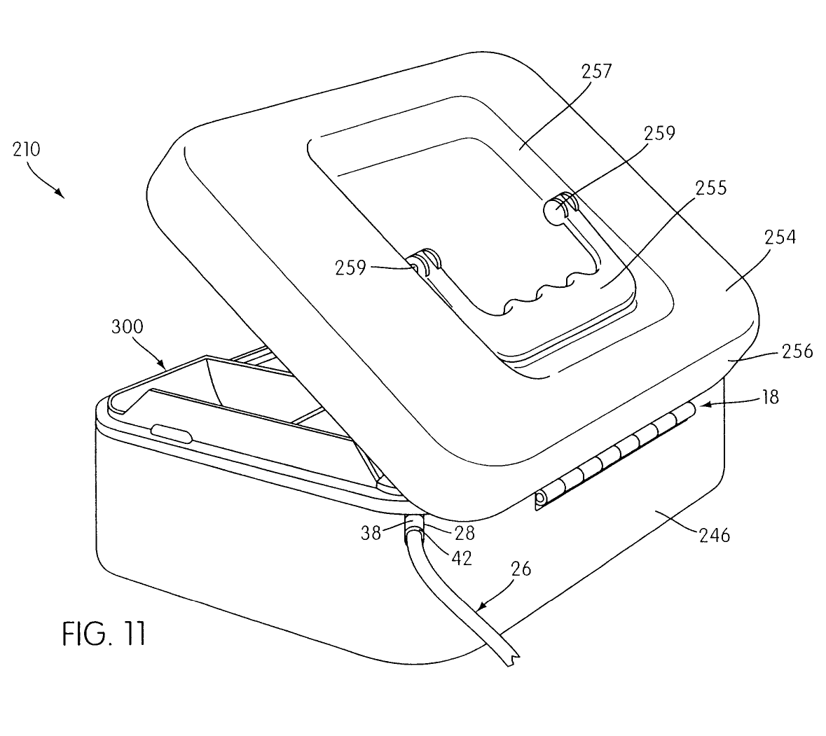

As shown in FIGS. 11 and 13, the storage unit 210 includes a storage tray 300 removably connected with the base 214 thereof. The storage tray 300 includes a plurality of storage bins 301 arranged within the storage tray 300 in horizontal rows and vertical columns. Alternatively, the storage tray 300 could be configured to house a number of storage bins having different sizes. In such alternative configurations, the storage bins would not necessarily be arranged in precise horizontal rows and vertical columns.

The storage tray 300 has an outer peripheral portion 302 removably supported on the upper surface 252 (FIG. 12) of the upstanding sidewall 246. The outer peripheral portion 302 is configured so as not to extend outwardly from the base 214, but may do so if constructed not to interfere with the opening and closing of the lid 216 relative to the base 214.

A pair of upstanding support walls 306 extend from the outer peripheral portion 302 to support the depending sidewall 256 of the lid 216. The pair of upstanding support walls 306 may or may not contact the depending sidewall 256 depending on the type of storage unit the storage tray 300 is implemented.

When the storage tray 300 is removably supported on the upper surface 252 of the base 214, as shown in FIG. 11, the storage tray 300 at least partially closes the groove 28, similar to the concept of the lid 116 at least partially closing the respective groove 128 in FIG. 6.

The storage tray 300, which may be constructed from plastic, rubber or some other sufficiently resilient or rigid material, has a shape that compliments the shape of the base 214, such that the storage tray 300 fits securely within the base 214. However, the shape of the storage tray 300 can be matched to the shape of any base or any lid (e.g., by molding or some other manufacturing process), and is not limited to the shapes of the base 214 and the lid 216.

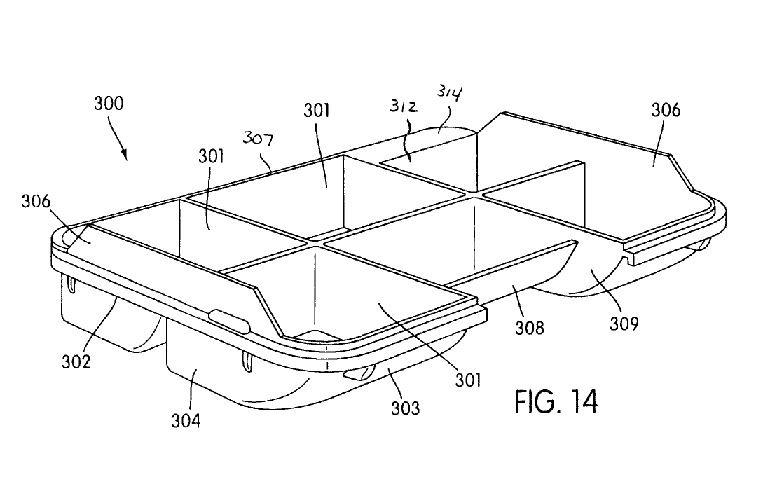

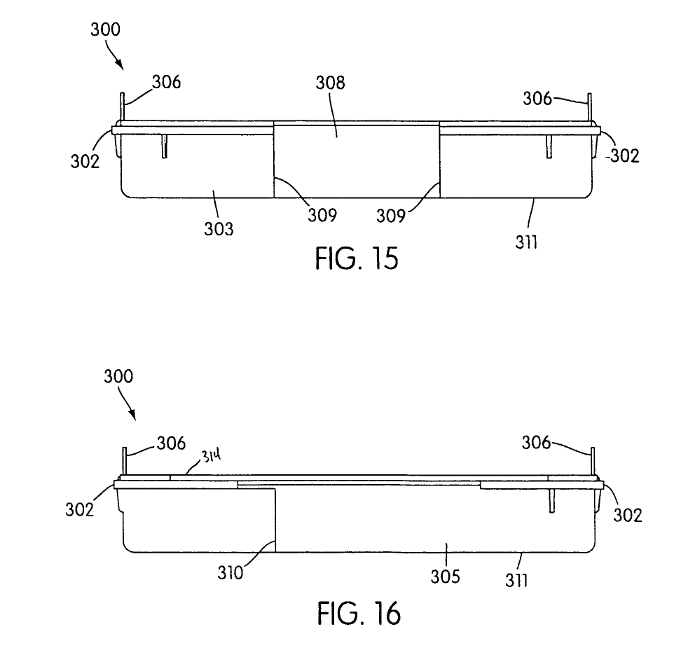

FIGS. 14-16 show the storage tray 300 in greater detail. As illustrated, the storage tray 300 includes a pair of side portions 304 integrally connected with a central portion 307. Each side portion 304 has a front surface 303 and the central portion 307 has a front surface 308 formed between the front surfaces 303 of the side portions 304. Each side portion 304, in FIG. 14, has a generally arcuate cross-sectional configuration, but may be constructed into other shapes as well. FIG. 15 shows a rear surface 310 extending across a rear of the side portions 304 and the central portion 307. FIGS. 15 and 16 show a bottom surface 311 extending across a bottom of the side portions 304 and the central portion 307.

The front surface 308 of the central portion 307 is partially recessed with respect to the front surfaces 303 of the side portions 304 (i.e., the front surface 308 is positioned closer to the rear surface 305 of each side portion 304 than the front surface 303 of each side portion 304). FIG. 14 shows the front surface 308 of the central portion 307 spaced rearwardly of the front surfaces 303 by an interior marginal portion 309 of each side portion 304. The interior marginal portions 309, in combination with the recessed relationship between the front surfaces 303 and 308, defines an open area therebetween.

When the storage tray 300 is removably supported in the storage unit 210, for example, the open area is configured to receive at least one of the lock receiving structure 284, the lock actuating portion in the form of a key receiving portion 286, the locking flange 288 and the actuator 287 of the locking device 224. The open area may receive more than one of these elements as shown in FIGS. 11 and 13 where, for example, the locking flange 288 and the actuator 287 are positioned in the open area. Any portion of the locking device 24, 124 or 224 can be received or positioned in the open area.

The open area can be formed to be different sizes and shapes, so long as the open area is configured to permit operation of a locking device, e.g., locking device 224, associated with a respective storage unit, e.g., storage unit 210.

In an alternative embodiment, the central portion 307 can be eliminated and each side portion 304, e.g., the front surfaces 303 thereof, can be configured to define at least a portion of the open area.

As shown in FIG. 16, the rear surface 305 of the storage tray 300 may include a recessed portion 310, which corresponds to a generally planar portion 312 and extends below a generally horizontally extending surface 314 shown in FIG. 14. The recessed portion 310 and the surface 314 may be positioned adjacent to the groove 28 when the storage tray 300 is removably inserted into the base 214.

Although not shown, a space is provided beneath the storage tray 300 when removably inserted into the base 214, so that a user can place items 12 below the tray 300. The recessed portion 310 can allow the retaining element 38 and the leading end 40 of the tether 26 to move freely without affecting contents, e.g., items 12, stored within a space in the base 214 provided beneath the storage tray 300.

Alternatively, the recessed portion 310 can be configured to assist collecting excess tether (e.g., if the storage unit 210 is moved toward an immovable object to which the storage unit is attached by the tether). For example, the recessed portion 310 can cooperate with the leading end 40 of the tether 26 to deflect the leading end 40 within the space formed beneath the storage tray 300 so that excess tether can be collected.

The storage tray 300 could be implemented with any storage unit, for example, storage units 10, 110, and is not limited to implementation with only the storage tray 210. For example, if the storage tray 300 were operatively associated with the storage unit 110, the storage tray 300 could be removably mounted to the upper surface 152 of the upstanding peripheral sidewall 146. As a result, the lower surface 161 of the depending peripheral sidewall 156 of the storage unit 110 would abut the outer peripheral portion 302 of the storage tray 300 when the base 114 and the lid 116 move into the closed position thereof. Also, in some applications, the storage tray 300 may be configured to be supported on a bottom surface of the base.

### Operation

The storage unit of the invention is used as follows. A user can open one of the storage unites 10, 110, 210 to gain access to the interior of the respective base 14, 114, 214 to place items 12 therein for storage. One way to secure the storage units 10, 110, 210 to the immovable object 30 will be described below. First, the user would wrap the looped segment 32 around the immovable object 30 so that the leading end 40 of the tether 26 can be thread through the looped segment 32. After threading the leading end 40 through the looped segment 32, the user may pull on the retaining element 38 at the leading end 40 of the tether to secure the tether 26 around the immovable object 30.

Next, the user should pivot the lid 16, 116, 216 about the pivot 18 to gain access to the groove 28, 128 within the upstanding sidewall 46, 146, 246. The groove 28, 128 extends past the lower peripheral portion of the depending sidewall 56, 156, 256 of the respective lid 16, 116, 216 when the lid and the base are moved into their closed position. The leading end 40 of the tether 26 being capable of being disposed within the groove 28, 128 such that the retaining element 38 is disposed within an interior of the base 14, 114, 214. The groove is then enclosed with the lid 16, 116 or the storage tray 300 so that the sidewall abutting surface 42 of the retaining element 38 will engage the interior marginal surface 44 surrounding the upwardly facing groove 28, 128 to prevent withdrawal of the leading end 40 of the cable 26 from the interior of the base 14, 114, 214.

Once the cable 26 is received in the groove 28, 128, the base 14, 114, 214 and the lid 16, 116, 216 are moved into their closed position and locked to prevent relative pivotal movement therebetween. In this way, items placed in the interior of the base can be lockingly secured therein when the locking device is activated. Once locked, the storage unites 10, 110, 210 are lockingly secured to the immovable object 30.

A user having an existing lockable storage unit may form an upwardly facing groove in an upstanding peripheral sidewall of the existing base. Alternatively, the user may form the upwardly facing groove in a depending sidewall of the lid. After forming the groove, a tether could be separately provided, for securing the existing storage unit to an immoveable object.

While the principles of the invention have been made clear in the illustrative embodiments set forth above, it will be apparent to those skilled in the art that various modifications may be made to the structure, arrangement, proportion, elements, materials, and components used in the practice of the invention. For example, a groove, substantially identical to the groove 28, could be formed in an existing storage unit having a base and a lid pivotally attached to one another. In that case, the tether 26 could be used with existing storage units retrofitted to provide the groove substantially identical to the groove 28. The operation of the tether 26 and its relationship with the groove formed in the existing storage unit would be substantially identical to the embodiment shown in FIGS. 1-5.

Also, the locking devices 24 and 224 and various hinge types described above can be used on any of the embodiments of the storage unites 10, 110 and 210.

Thus, the foregoing preferred specific embodiments have been shown and described for the purpose of illustrating the functional and structural principles of this invention and are subject to change without departure from such principles. Therefore, this invention includes all modifications encompassed within the spirit and scope of the disclosure.

We claim the following:

1. A storage unit for storing items comprising:
a base with an upstanding peripheral sidewall and an upwardly open groove formed in the upstanding peripheral sidewall;
a lid having a depending peripheral sidewall and being pivotally coupled to the base via a hinge for relative pivotal movement therebetween, the lid and the base being movable into a closed position wherein the lid substantially encloses the base, wherein the depending sidewall has a lower peripheral portion that coextends an upper peripheral portion of the upstanding sidewall;
a tether having a looped segment on a trailing end thereof for securing to an immoveable object and a retaining element on a leading end thereof;
a locking device configured to be capable of lockingly securing the lid and the base to one another to prevent relative pivotal movement therebetween;
wherein the groove within the upstanding sidewall extends past the lower peripheral portion of the depending sidewall when the lid and the base are moved into their closed position; the leading end of the tether being capable of being disposed within the groove such that the retaining element is disposed within an interior of the base; the groove being enclosed with the depending sidewall of the lid; and the retaining element abutting the sidewall to prevent withdrawal of the leading end of the tether from the interior of the base.

2. The storage unit of claim 1, further comprising a storage tray received in the base, the storage tray having at least one storage bin.

3. The storage unit of claim 2, wherein the storage tray is removable from said base.

4. The storage unit of claim 2, wherein the storage tray defines an open area configured to receive the locking device.

5. The storage unit of claim 2, wherein the storage tray defines a recessed portion configured to receive the retaining element and the leading end of the tether.

6. The storage unit of claim 1, wherein the locking device comprises:
a lock receiving structure provided on at least one of the base and the lid, the lock receiving structure having at least one portion extending radially from the at least one of the base and the lid;
a lock actuating portion provided on at least one of the base and the lid; and
a locking flange associated with the lock actuating portion and configured to be capable of cooperating with the at least one portion of the lock receiving structure to lockingly secure the base and the lid to one another to prevent relative pivotal movement between the base and the lid.

7. The storage unit of claim 6, wherein the locking device is a key lock and wherein the lock actuating portion is capable of receiving a key such that insertion of the key into the lock actuating portion allows the lock actuating portion and the locking device to be moved into (a) an unlock position, wherein the base and the lid are able to pivot relative to one another and (b) a lock position, wherein the base and the lid to are prevented from pivotally moving relative to one another.

8. The storage unit of claim 7, wherein, after insertion of the key, the lock actuating portion is rotatable between the unlock position thereof and the lock position thereof.

9. The storage unit of claim 7, wherein the locking flange is rotatably mounted to the lock actuating portion, such that when the lock actuating portion is moved into the lock position thereof, the locking flange is configured to lockingly engage the at least one portion of the lock receiving structure to prevent pivotal movement between the base and the lid.

10. The storage unit of claim 1, wherein the locking device comprises:
a lock receiving structure provided on at least one of the base and the lid, the lock receiving structure having at least one portion extending radially from the at least one of the base and the lid and having a tab engaging portion;
an actuator provided on at least one of the base and the lid, the actuator including a tab portion configured to engage the tab engaging portion of the lock receiving structure to secure the base and the lid to one another to prevent relative pivotal movement therebetween;
a lock actuating portion provided on at least one of the base and the lid; and
a locking flange associated with the lock actuating portion and configured to be capable of cooperating with the at least one portion of the lock receiving structure to lockingly secure the base and the lid to one another to prevent relative pivotal movement between the base and the lid.

11. The storage unit of claim 10, wherein the locking device is a key lock and wherein the lock actuating portion is capable of receiving a key such that insertion of the key into the lock actuating portion allows the lock actuating portion and the locking device to be moved into (a) an unlock position, wherein the base and the lid are able to pivot relative to one another and (b) a lock position, wherein the base and the lid to are prevented from pivotally moving relative to one another.

12. The storage unit of claim 11, wherein, after insertion of the key, the lock actuating portion is rotatable between the unlock position thereof and the lock position thereof.

13. The storage unit of claim 11, wherein the locking flange is rotatably mounted to the lock actuating portion, such that when the lock actuating portion is moved into the lock position thereof, the locking flange is configured to lockingly engage the at least one portion of the lock receiving structure to prevent pivotal movement between the base and the lid.

14. The storage unit of claim 11, wherein the actuator extends through the upstanding peripheral sidewall of the base or the depending peripheral sidewall of the lid.

15. The storage unit of claim 10, wherein the actuator is operatively associated with the tab portion such that the actuator and the tab portion can be moved into (a) an open position, wherein the actuator is moved inwardly, toward an interior of the base or the lid, and the tab portion is moved inwardly to engage the tab engaging portion of the lock receiving structure and (b) a closed position, wherein the tab portion engages the tab engaging portion of the lock receiving structure to prevent relative pivotal movement between the base and the lid.

16. The storage unit of claim 1, wherein the base has a bottom surface integral with the upstanding peripheral sidewall.

17. The storage unit of claim 1, wherein the bottom surface is capable of being covered with a removable protection pad for protecting the items and the bottom surface.

18. The storage unit of claim 1, wherein, except for said groove, said upstanding peripheral sidewall of the base extends along the entire perimeter of the base.

19. The storage unit of claim 1, wherein the hinge is a living hinge connected to the lid and the base.

20. The storage unit of claim 1, wherein the base has an interior marginal surface providing the groove, the retaining element of the tether being configured to engage the interior marginal surface of the base to prevent withdrawal of the leading end of the tether from the interior of the base.

21. The storage unit of claim 1, wherein the hinge comprises shaft members extending from one of the base and the lid and journaling openings formed in the other of the base and the lid, the shaft members fitting in and rotating in the journaling openings.

22. The storage unit of claim 1, wherein the hinge comprises projections extending from the lid and projections extending from the base, the projections extending from the lid and the base providing journaling openings configured to receive a shaft member therethrough, the shaft member being capable of fitting in and rotating in the journaling openings to pivotally connect the lid and the base.

23. The storage unit of claim 1, wherein the base has a recessed portion formed therein, the hinge extending through the recessed portion of the base.

24. The storage unit of claim 1, wherein the depending peripheral sidewall abuts the upstanding sidewall such that the depending peripheral sidewall and the upper peripheral portion extend in a common vertical plane.

25. The storage unit of claim 1, wherein the tether is a cable or a chain.

26. A method of retrofitting an existing storage unit for securement to an immovable object, the existing storage unit comprising a base with an upstanding peripheral sidewall and a lid having a depending peripheral sidewall and being pivotally coupled to the base via a hinge for relative pivotal movement therebetween, the lid and the base being movable into a closed position wherein the lid substantially encloses the base, wherein the depending sidewall has a lower peripheral portion that coextends an upper peripheral portion of the upstanding sidewall, the method comprising:
forming a groove in the upstanding peripheral sidewall of the existing base or lid;
providing a tether having a looped segment on a trailing end thereof for securing to the immoveable object and a retaining element on a leading end thereof;
extending the groove past the lower peripheral portion of the depending sidewall or past the upper peripheral portion of the upstanding sidewall when the lid and the base are moved into their closed position;
enabling the leading end of the tether to be disposed within the groove such that the retaining element is disposed within an interior of the base or the lid;
enclosing the groove with the depending sidewall of the lid or with the upstanding sidewall of the base; and
abutting the leading end of the tether with the depending sidewall of the lid or the upstanding sidewall of the base to prevent withdrawal of the leading end of the tether from the interior of the base or the lid.

27. A method of storing items for storage, comprising:
providing a storage unit comprising a base with an upstanding peripheral sidewall;
providing a lid having a depending peripheral sidewall and being movable coupled to the base via a hinge for relative movement therebetween, the lid and the base being movable into a closed position wherein the lid substantially encloses the base, wherein the depending sidewall has a lower peripheral portion that abuts an upper peripheral portion of the upstanding sidewall when the lid and the base are moved into the closed position thereof, the method comprising:
forming a groove in the upstanding peripheral sidewall of the base or in the depending sidewall of the lid;
providing a tether having a looped segment on a trailing end thereof for securing to the immoveable object and a retaining element on a leading end thereof;
extending the groove past the lower peripheral portion of the depending sidewall or past the upper peripheral portion of the upstanding sidewall when the lid and the base are moved into their closed position;
enabling the leading end of the tether to be disposed within the groove such that the retaining element is disposed within an interior of the base or the lid;
enclosing the groove with the depending sidewall of the lid or with the upstanding sidewall of the base; and
abutting the leading end of the tether with the depending sidewall of the lid or the upstanding sidewall of the base to prevent withdrawal of the leading end of the tether from the interior of the base or the lid.

28. The method according to claim 27, further comprising providing a locking device configured to be capable of lockingly securing the lid and the base to one another to prevent relative pivotal movement therebetween, such that items placed in the interior of the base can be lockingly secured therein when the locking device is activated to prevent relative pivotal movement between the lid and the base.

29. The method according to claim 28, wherein the locking device lockingly secures the base and the lid to prevent withdrawal of the leading end of the tether from the interior of the base or the lid.

30. A storage unit for storing items comprising:
a base with an upstanding peripheral sidewall;
a lid having a depending peripheral sidewall and being movably coupled to the base via a hinge for relative pivotal movement therebetween, the lid and the base being movable into a closed position wherein the lid substantially encloses the base,
an upwardly open groove formed in one of the upstanding peripheral sidewall of the base and the depending peripheral sidewall of the lid, the upwardly open groove being configured to receive one end of a tether therethrough, the one end of the tether being disposed within an interior of the base and being configured to abut the upwardly open groove; and
a locking device configured to be capable of lockingly securing the lid and the base to one another to prevent relative movement therebetween;
wherein a portion of the groove is at least partially closed when the lid and the base are moved into their closed position to prevent withdrawal of the one end of the tether from the interior of the base.

31. A storage unit for storing items comprising:
a base with an upstanding peripheral sidewall and an upwardly open groove formed in the upstanding peripheral sidewall;
a lid having a depending peripheral sidewall and being pivotally coupled to the base via a hinge for relative pivotal movement therebetween, the lid and the base being movable into a closed position wherein the lid substantially encloses the base,
wherein the depending sidewall has a lower peripheral portion that coextends an upper peripheral portion of the upstanding sidewall;
a cable tether having a looped segment on a trailing end thereof for securing to an immoveable object and a retaining element on a leading end thereof;
a locking device configured to be capable of lockingly securing the lid and the base to one another to prevent relative pivotal movement therebetween, wherein
the groove within the upstanding sidewall extends past the lower peripheral portion of the depending sidewall when the lid and the base are moved into their closed position,
the leading end of the cable is capable of being disposed within the groove such that the retaining element is disposed within an interior of the base,
the groove is enclosed with the depending sidewall of the lid, and
the retaining element abuts the sidewall to prevent withdrawal of the leading end of the cable from the interior of the base.
